(19) United States
(12) Patent Application Publication
(10) Pub. No.: US 2005/0270994 A1
(43) Pub. Date: Dec. 8, 2005

(54) Method for the broadcasting of multimedia messages to a heterogeneous fleet of terminals

(76) Inventors: Philippe Caloud, Saint-Ismier (FR); Rodolphe Marsot, Grenoble (FR); Jean-Charles San Severino, Montbonnot Saint Martin (FR)

Correspondence Address: PERMAN & GREEN, 425 POST ROAD, FAIRFIELD, CT, 06824, US

(21) Appl. No.: 11/025,792

(22) Filed: Dec. 29, 2004

(30) Foreign Application Priority Data
Dec. 31, 2003 (FR) 03 51237

(51) Int. Cl. H04J 3/24

(52) U.S. Cl. 370/312

(57) ABSTRACT

So as to limit the resources required by the mass broadcasting of multimedia messages, a multimedia content is identified by a service identifier. In the MMS-C server responsible for the broadcasting, this service identifier is associated with a certain number of multimedia messages preformatted as a function of a type of terminal. The requests for retrieval of the content therefore relate to a service identifier and a type of terminal instead of a URL of a message. Thus excessive communications between providers of contents and telephony operators are avoided. The excessive replication of a multimedia message on an MMS-C platform is also avoided.

### BACKGROUND OF THE INVENTION

1. Field of the Invention

An object of the invention is a method for the broadcasting or distribution of multimedia messages to a fleet of terminals.

The field of the invention is therefore that of the mass or bulk broadcasting of messages known as MMS (Multimedia Message Service) messages also known as multimedia messages. A multimedia message is a message comprising several types of media including text, still or moving pictures, sound etc.: this list is not exhaustive. The different media are assembled in a single message and synchronized by the use of a presentation language of the SMIL (Synchronized Multimedia Integration Language) type. Such languages are also, for example, the WML (Wireless Markup Language) or HTML (Hyper Text Markup Language). A multimedia message is therefore a file comprising a sequence of instructions corresponding to one of these languages, for examples of the HTML type.

More particularly, the field of the invention is that of the mass broadcasting of MMS messages to mobile terminals connected to a telecommunications network of a mobile telephony operator.

It is an aim of the invention to facilitate the mass broadcasting of MMS messages.

It is yet another aim of the invention to limit the system resources required for the mass broadcasting of MMS messages.

It is another aim of the invention to provide a more efficient guarantee of the matching between a multimedia content and the terminal at which it is restored.

2. Description of the Prior Art

In the prior art, MMS messages are sent through an interpersonal communications service offering an internal mechanism for the storage and forwarding of multimedia messages. These messages are sent directly to the mobile terminal having MMS capacities, as soon it is visible and available in the operator's network.

In general, the traffic distribution encountered is chiefly one-to-one (from one terminal to another terminal), also known as unicast or point-to-point traffic, without any major constraints on the time limit of reception of MMS messages.

In the prior art, MMS messages are also used as a carrier for services for the broadcasting of contents to users: these are mass distribution services such as, for example, regular information services (sports, weather, etc.) or news events (a goal during a football match, the launching of a product, etc.). These messages of course also contain sound, images and video. They are sent to several thousands or even millions of subscribers simultaneously and practically in real time. This is then a 1-to-N (one piece of information to N terminals) traffic distribution with heavy constraints on MMS message reception time.

In the prior art, generic MMS-C platforms or hubs are proposed by equipment suppliers to telephony operators, whatever the traffic models concerned, i.e. whether they are interpersonal or involve the mass distribution of content. However, starting from the standardization committee level itself, the specific characteristics of the MMS-based content broadcasting model are taken into account, especially at the interface between the telephony operator's MMS-C platforms and a server of a content provider. This is the MM7 interface defined by the 3GPP and the OMA (Open Mobile Alliance).

In the prior art, with respect to these MM7 specifications, a message content broadcasting service using MMS messages consists of an application developed by a service provider, or content provider, connected to the MMS-C platform of a telephony operator. This is essentially a broadcasting service where the same piece of information conveyed by the same MMS message is sent to all the subscribers to the service.

To send an MMS message to the MMS-C platform in using the MM7 interface, the content provider generates a request containing, inter alia, the MMS message to be sent and two addresses: the address of the MMS message and the address of the recipient or addressee, i.e. in fact the address of the recipient's terminal. The recipient's address is usually a telephone number, but an IP address or an electronic mail address can also be used.

Several recipients/terminals can be addressed simultaneously in a same request and for a same MMS. In practice, however, the sending remains limited to a few hundreds of addresses addressed simultaneously in a same request.

The working of an MMS-C standard is presented in greater detail in the specifications of the OMA and the 3GPP, especially in the document OMA-MMS-ENC-V1_{—}2-20030915-C.doc.

However, this standard architecture has a certain number of drawbacks for the broadcasting services. In particular, the use of the same architecture and the same internal mechanisms as in the case of an interpersonal MMS service shows the following drawbacks in the case of the use of services for the broadcasting of MMS messages.

Thus, the content provider is obliged to send a same MMS message several times in changing the list of addressees or recipients at each dispatch. For example, to send a same content to one million users, if the MMS-C accepts a maximum of hundred recipients simultaneously, the content provider is obliged to send the same content 10,000 times to the MMS-C platform. In present-day platforms, vendors even recommend the sending of a message to only one recipient. There is therefore a processing cost for a service provider who is obliged to manage a complex mechanism of a stream of messages/recipients with the MMS-C platform.

On a present-day MMS-C platform, an MMS message is processed, duplicated and stored as many times as there are recipients. At present, for a service for broadcasting one and the same piece of information to a million subscribers, this piece of information is stored one million times in the MMS-C platform. There is therefore substantial extra cost in terms of software, hardware and licenses, especially relating to databases.

At present, an MMS-C platform creates as many different notifications, sent by SMS (Short Message Service) as there are recipients.

At present also, the mass broadcasting of MMS messages necessitates the setting up of a matching of content to the type of terminal of the recipient. If this matching is done by the content supplier, then it means that this content supplier should additionally maintain a database by which a recipient can be associated with a type of terminal. If this matching is done by the MMS-C platform, that creates a processing load with the additional risk that this automatic matching might modify the appearance of the content, which would be detrimental to the content provider.

Similarly, at present, when the content provider wishes to receive confirmation of the proper delivery of the messages by the operator, he receives confirmation for each MMS message sent, i.e. in the example, one million confirmations if all the messages have been properly delivered.

The invention resolves these problems by defining a novel system for the addressing of the MMS messages sent by a content provider. Thus, instead of the recipient's address, a message for the configuration of a broadcasting of content through an MMS message comprises at least one service identifier, and as many MMS messages as there are types of terminal to which the broadcasting is addressed, each MMS message being associated with one type of terminal.

A notification message, comprising at least the service identifier, is then sent to all the terminals of types cited in the configuration message known by the telephony operator who has received the configuration message.

A message for the retrieval or transfer of a MMS message will then comprise a service identifier and a type of terminal identifier enabling the operator to send the right MMS message in response to the retrieval message.

The invention therefore enables the sending of only one configuration message for all the recipients, the creation of only one notification message and the storage of the MMS message to be broadcast only once per type of terminal.

### SUMMARY OF THE INVENTION

An object of the invention therefore is a method for the broadcasting of multimedia messages to a fleet of terminals wherein:
a server of a telephony operator receives a message of configuration of broadcasting of a multimedia content, the configuration message comprising at least one service identifier field, one identifier field of a type of terminal and, for each type of terminal identified by the configuration message, an associated multimedia message, a multimedia message being compatible with the type of terminal with which it is associated,
the operator's server records the configuration message in a storage memory, the configuration message being then identified in the storage memory by the service identifier, each multimedia message of the configuration message being associated with this service identifier,
the operator's server sends at least one message of notification of reception of a multimedia message to at least one mobile terminal of a subscriber with the telephony operator, the notification message comprising a multimedia message identifier field itself comprising at least one service identifier field whose content is that of the service identifier field of the configuration message, the subscriber being referenced in a subscriber database.

Advantageously, the invention is also characterized in that:
the operator's server receives a multimedia message retrieval message, the retrieval message comprising a type-of-terminal field and, in a multimedia message identifier field, a service identifier field, and,
the operator's server scans the storage memory to find a configuration message identified by the content of the service identifier field,
the operator's server scans the configuration message found to find a multimedia message identified by content of the type-of-terminal field,
the operator's server sends the multimedia message found in response to the retrieval message.

Advantageously, the invention is also characterized by the fact that the multimedia message identifier field of the notification message also has a type-of-terminal field, the content of this type-of-terminal field being extracted from the subscriber database.

Advantageously, the invention is also characterized by the fact that:
the operator's server receives a message for the retrieval of a multimedia message, the multimedia message identifier field of the retrieval message comprising a multimedia message identifier field and a type-of-terminal field,
if there is no identity between the type-of-terminal field of the retrieval message, and the type-of-terminal field of the multimedia message identifier field, then the server of the operator updates the subscriber database to take account of the change in terminal of the subscriber,
the operator's server scans the storage memory to find a configuration message identified by content of the service identifier field,
the operator's server scans the configuration message found to find a multimedia message identified by content of the type-of-terminal field of the retrieval message,
the operator's server sends the multimedia message found in response to the retrieval message.

Advantageously, the invention is also characterized by the fact that if, in the configuration message found, there is no multimedia message corresponding to the content of the type-of-terminal field of the retrieval message, then the server sends a default multimedia message.

Advantageously, the invention is also characterized by the fact that:
the operator's server receives a transfer message comprising a recipient identifier field, and a multimedia message identifier field comprising a service identifier field,
the server sends the terminal identified by the recipient identifier field a notification message comprising, in a multimedia message identifier field, the content of the service identifier field of the transfer message.

Advantageously, the invention is also characterized by the fact that:
the server's operator computes, for each multimedia message of the configuration message, a digital summary of the message, this summary being recorded in a digital summary field associated with the multimedia message in the storage memory.

Advantageously, the invention is also characterized by the fact that:
the operator's server receives a transfer message, the transfer message comprising a recipient identifier field, and a multimedia message,
the operator's server computes a digital summary of the multimedia message of the transfer message,
the operator's server makes a search in the storage memory for the multimedia message for which the content of the digital summary field corresponds to the digital summary computed for the multimedia message of the transfer message,
the operator's server sends the terminal, identified by the content of the recipient field of the transfer message, a notification message comprising, in a multimedia message identifier field, a service identifier field whose content is the content of the service identifier field associated with the multimedia message found in the storage memory.

Advantageously, the invention is also characterized by the fact that the operator's server associates at least one access computer with each service identifier.

Advantageously, the invention is also characterized by the fact that the configuration message includes an address for the sending of access statistics.

### BRIEF DESCRIPTION OF THE DRAWINGS

The invention will be understood more clearly from the following description and the accompanying figures. These figures are given by way of an indication and in no way restrict the scope of the invention. Of these figures:

FIG. 1 illustrates means implementing the method according to the invention.

FIG. 2 illustrates steps of the method according to the invention.

### MORE DETAILED DESCRIPTION

In the description, when an action is attributed to an apparatus, this action is in fact performed by a microprocessor of the apparatus controlled by instruction codes recorded in a program memory of the apparatus.

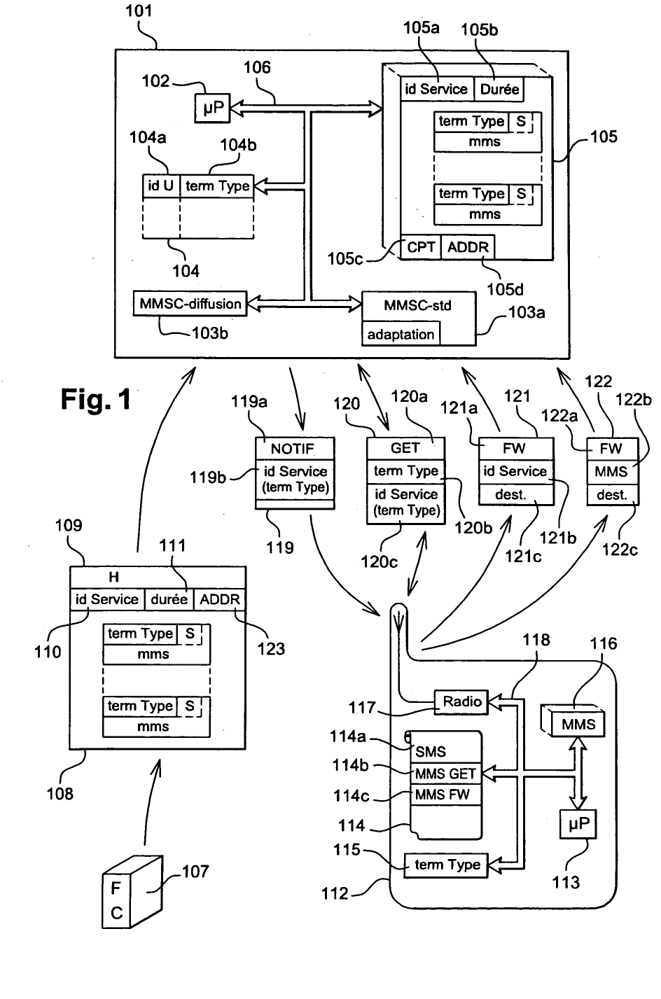

FIG. 1 shows a server 101 of a mobile telephony operator, the server 101 being an MMS-C platform. The server 101 comprises a microprocessor 102, an MMS-C standard program memory 103a, an MMS-C broadcasting program memory 103b, a memory 104 for associating user identifier and type of terminal, and a memory for the storage of broadcasting configuration messages 105. The elements 102 to 105 are connected through a bus 106. In practice, the memories 104 and 105 may be distributed on other servers of the mobile telephony operator in the form of databases to which the server 101 then has access.

The memory 103a has instruction codes for the implementation of interpersonal MMS-C services, including the adaptation of the messages. The memory 103b has instruction codes for the implementation of MMS-C broadcasting services according to the invention.

The memory 104 has at least two columns, one column 104a to record a user identifier, and one column 104b to record a type of terminal. A user identifier is a telephone number (MSISDN), an IP address version 4 or 6, etc. A type of terminal is identified by an alphanumeric value defined by the maker of the terminal, and agreed upon between the mobile telephony operator and the content providers making use of the operator's services.

The memory 105 has as many recordings as there are broadcasting configuration messages received by the server 101. A recording has a service identifier field 105a; in one variant, a recording also has a field 105b of duration of validity of the recording. A recording also has one or more multimedia messages, each of these multimedia messages being referenced by one type-of-terminal field. In one variant, a multimedia message is also associated with a digital summary field.

FIG. 1 also shows a server 107 of a content provider capable of sending a broadcasting configuration message 108 according to the invention. Such a message 108 has a header 109 by which the message 108 can be recognized as being a configuration message of a multimedia broadcast. This header thus also enables the message 108 to be conveyed between the server 107 and the server 101.

The message 108 also has a service identifier field 110 and, in one variant, a duration of validity field 111. The message 108 also has one or more multimedia messages, each of these multimedia messages being associated with a type of terminal.

FIG. 1 also shows a terminal 112 provided with MMS capacities. In a preferred implementation, such a terminal is a mobile telephone. However, the term “terminal” can be interpreted in the broad sense for the implementation of the invention. Any apparatus provided with MMS capacities may indeed fulfill the role of the terminal for the implementation of the method according to the invention.

The terminal 112 has a microprocessor 113, a program memory 114, a terminal type memory 115, an MMS message storage memory 116 and radio interface circuits 117 for interfacing with the network of the telephony operator managing the server 101. The elements 113 to 117 are connected by a bus 118.

The memory 114 has at least one zone 114a comprising instruction codes for the management of SMS messages, one zone 114b comprising instruction codes for the retrieval of MMS messages, and one zone 114c comprising instruction codes for the transfer of MMS messages.

The terminal 112 is thus capable of receiving at least one SMS message 119 for notifying reception of the MMS message. The terminal 112 is also capable of sending at least one message for the retrieval of an MMS message. The terminal 112 is furthermore capable of sending at least one message 121-122 for the transfer of an MMS message.

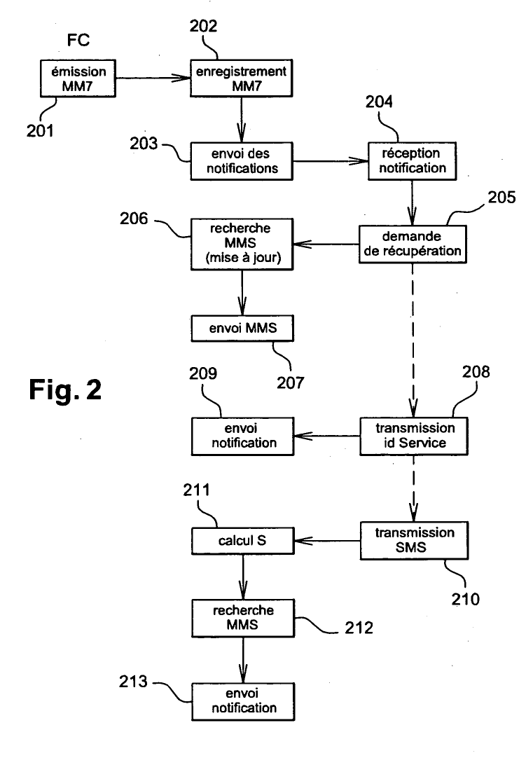

FIG. 2 shows a preliminary step 201 in which the server 107 of a content provider produces and sends the message 108 for the configuration of a broadcasting of content by MMS messages. In this step, the content provider has produced as many MMS messages as there are types of terminals to which the content provider wishes to broadcast the multimedia content. A terminal of a given type is indeed provided with certain capacities of multimedia restitution that vary from one type of terminal to another. These capacities, as far as the most obvious of them are concerned, are its screen size, the number of colors displayed, the capacity of the terminal to display or not display moving pictures, its sound capacities etc. A same multimedia content must therefore be formatted differently depending on the type of terminal at which it will be restored. For example, in the case of a football match, the score may be transmitted with a still image, or with a slow-motion sequence of the action that has led to a change in the score. Again, for example, in the case of the launching of a product, the advertising message may contain only one image or a motion sequence of varying length and varying colors. For example also in the case of a weather bulletin, this bulletin may or may not contain a motion sequence of a satellite shot. It can clearly be seen that the same piece of information/content may be illustrated differently depending on the restitution capacities of the terminal receiving this piece of information.

A message of configuration of a broadcast of a content via MMS messages therefore comprises, in the invention, as many MMS messages as there are types of recipient terminal for the content. It may be noted that, for a given type of terminal, a configuration message has one and only one MMS message.

From this step 201 the invention passes to a step 202 for the reception and recording of the message 108 by the server 101. In this step, the server 101 updates the memory 105 according to the content of the message 108. The server 101 identifies the message 108 as being a message for updating a broadcast of content according to the invention by means of the content of the header 109. This updating is done by the creation of a new recording in the memory 105, and by transferring the content of the message 108 to this new recording.

In one variant of the invention, for each MMS message of the message 108, the server 101 computes a digital summary, which it associates with the corresponding MMS message through a digital summary field. A digital summary of this kind is, for example, a checksum that is the result of the application of the MD5 algorithm or SHA-0.1 algorithm to the MMS message.

From the step 202, the invention passes to a step 203 for sending notifications of reception of an MMS message. In this step, the server 101 produces and sends SMS messages such as the message 119. The message 119 has at least one instruction code field 119a, whose content indicates that it is a message for the notification of reception of the MMS message, and one MMS message identifier field 119b. The MMS message identifier field has at least one service identifier field whose content is that of the service identifier field of the recording newly created at the step 202. In one variant, the MMS message identifier field of the message 119 also comprises a type-of-terminal field whose content is the type of terminal that the operator has associated with the recipient of the message 119. The MMS message identifier field of the notification message according to the invention corresponds to the URL (Universal Resource Locator) field of the messages notifying reception of an MMS message in the prior art.

This message thus created is sent to all the terminals that the server 101 is capable of associating with the contents of the type-of-terminal fields of the recording newly created at the step 202. This association is made by using the memory 104. For each type-of-terminal field of the recording newly created at the step 202, the server scans the memory 104 and more particularly the column 104b, to find the rows of the memory 104 for which the content of the field of the column 104b corresponds to the content of the type-of-terminal field of the recording newly created at the step 202. For each of the rows found (there may be none) the server produces and sends a message 119 whose recipient is identified by the content of the field of the column 104a of the row found.

In one variant, the memory 104 has an additional column used to associate a user identifier with a list of service identifiers. This list could be empty. In this variant, the list of service identifiers corresponds to a list of services to which the user subscribes. In this variant, for the step 203, a row is deemed to be found if the list of service identifiers of this row includes the service identifier of the recording newly created at the step 202.

In the invention, the server 101 creates at most N different notification messages where N is the number of MMS messages contained in the recording newly created at the step 202. In the invention, the address of the MMS message to be retrieved is indeed replaced by a service identifier which is the same for all the recipients. In one variant, this service identifier is associated with a type of terminal. In the invention, the memory space required to carry out a mass multimedia message broadcast is therefore limited to the recording of the broadcasting configuration message alone.

From the step 203, the invention passes to a step 204 in which the terminal 112 receives the notification message 119.

In the step 204, the terminal 112, provided with the MMS capacities, receives the message 119 notifying reception of an MMS message. The terminal 112 processes this message like any message whatsoever notifying reception of an MMS message. Indeed, setting up requires no modification of the MMS message recipient terminal.

From the step 204, the invention passes to a step 205 for the production and sending, by the terminal 112, of a message 120 for the retrieval of a multimedia message. The message 120 is produced from the content of the message 119, once again in a known way. In the URL field 120c of the retrieval message, the terminal 112 places the content of what it believes to be the URL field of the message 119, namely the field 119b. In practice, this content is actually the content of the MMS message identifier field, namely a service identifier and, in one variant, a type of terminal.

In addition to the MMS message identifier field 120b, the message 120 also contains a type-of-terminal field whose content is identical to the content of the memory 115. The message 120 also has a field 120a identifying the message 102 as being an MMS message retrieval message.

From the step 205, the invention passes to a step 206 for the reception and processing of the message 120 by the server 101.

In the variant where the field 120c of the message 102 has a type-of-terminal field, the server 101 compares the content of this field with the content of the field 120b of the message 120. If there is no identity, the server 101 updates the memory 104. This updating consists in changing the terminal type associated, in the memory 104, with the sender of the message 120 according to the content of the field 120b of the message 120.

In the step 206, the server 101 scans the memory 105 to find the recording for which the content of the service identifier field 105a corresponds to the content of the service identifier field of the MMS message identifier field 120c of the message 120. Once this recording has been found, the server 101 scans this recording to find the MMS message for which the associated terminal type corresponds to the content of the type-of-terminal field 120b of the message 120.

In a following step 207, the MMS message thus found is then sent in response to the retrieval message 120.

At the step 206, if the server 101 does not find any MMS message corresponding to the search criteria, then it uses a default MMS message in the recording found. This default message is given by the content provider in the configuration message 108. He may then make this default message undergo an automatic adaptation to the type of terminal of the user and he sends this adapted message in response to the message 120.

If the memory 105 does not contain any recording corresponding to the content of the service identifier field of the field 120c, then the server 101 responds to the message 120 by an error message.

In the invention, only N messages need to be saved, where N corresponds to a number of types of terminal, in order to broadcast a content to a very large number of recipients, namely a number in the range of 10 000 times N recipients.

Again in the invention, the cases in which an automatic adaptation of content is made are limited to the case where a recipient has changed a type of terminal without informing his telephony operator and without this type of terminal having been taken into account during the configuration of the broadcast.

FIG. 2 also shows a step 208 in which the terminal 112 produces and sends the server 101 a message 121 pertaining to the transfer of an MMS message. This step follows the reception by the terminal 112 of the message 119.

The message 121 has a field 121a whose content is an instruction code identifying the message 121 as a transfer message. The message 121 also has a field 121b whose content identifies an MMS message to be transferred. The message 121 also has a field 121c identifying a recipient.

The content of the field 121b corresponds to the content of the field 119b. The content of the field 121c is all that enables the identifying of a terminal to which an MMS message can be sent. The content of the field 121c may therefore be a telephone number, an Internet address, an electronic mail address etc.

From the step 208 the invention passes to a step 209 for the reception and processing by the server 101 of the message 121. In the step 209, the server 101 uses the content of the field 121b to find the recording in the memory 105. If the recording is found, then the server 101 uses the content of the field 121c to determine the type of recipient terminal.

If it is a telephone number, then the server knows that the recipient of the transfer is a mobile terminal, and the server 101 produces and sends out a message 119 type of message to this mobile telephone. In this case, the invention passes from the step 209 to the step 204.

If it is an electronic mail address, then the server 101 scans the recording found to find the MMS message corresponding to the electronic mail type and uses the MMS message thus found to compose an electronic mail image that is then sent to the address contained in the field 121c. An owner of a basic model telephone can thus transfer a multimedia message to an electronic mail address having a better rendition then the rendition accessible to him on his own mobile telephone: an item of electronic mail can be consulted on a personal computer which is not restricted in terms of restitution of multimedia content.

FIG. 2 also shows a step 208 in which the terminal 112 produces and sends the server 101a message 122 pertaining to the transfer of an MMS message.

The message 122 has a field 122a whose content is an instruction code identifying the message 122 as a transfer message. The message 122 also has a field 122b whose content is an MMS message to be transferred. The message 122 also comprises a field 122c identifying a recipient.

The content of the field 122c is anything that enables the identification of a terminal to which an MMS message can be sent. The content of the field 122c may therefore be a telephone number, an Internet address, an electronic mail address etc.

From the step 210, the invention passes to a step 211 for the reception and processing of the message 122 by the server 101.

In the step 211, the server 101 computes a digital summary of the content of the field 122b. The algorithm used to compute this summary is the same as the one used in the step 202.

From the step 211, the invention passes to a step 212 for making a search in the memory 105 for an MMS message. In the step 212, the server 101 scans all the MMS messages of the memory 105 until it find the message for which the digital summary pre-computed at the step 202 corresponds to the digital summary computed at the step 211.

If the server 101 does not find such an MMS message, then the transfer message 122 is processed as a standard interpersonal message.

If the server 101 finds an MMS message of this kind, then the invention passes to a step 213 for sending a notification message 119. Having found an MMS message, the server 101 has knowledge of the recording identifier containing this MMS message. The server 119 is therefore capable of producing a notification message 119. This message is sent to the addressee identified by the content of the field 122c. Once a service identifier has been found, the message 122 is processed like the message 121.

In one variant of the invention, the configuration message also has the validity duration field 111. This field is preferably a date of end of validity of the configuration message. In this variant, the server 101 records the content of the field 111 in the field 105b. At regular intervals, the server 101 compares the content of the fields 105b with the current date. The recordings for which the content of the field 105b is below the current date are then erased. All the messages received by the server 101 relating to these recordings will then be ignored, or will prompt the sending of an error message in response.

In another variant of the invention, each recording of the memory 105 has a counter field 105c. This field enables the recording of a numerical value. When the recording is created, at the step 202, the content of the field 105c is initialized at the value 0. In this variant, in the step 206, the content of the counter field 105c of the recording found is augmented by one unit. The field 105c serves as an access counter to the digital content identified by the service identifier contained in the field 105a. It is thus possible to know are many times a given digital content has been accessed. This information concerns especially to the content provider who can thus obtain an idea of the interest taken in his content. In this variant, the server 101 implements a communications protocol of the HTTPS (Hyper Text Transfer Protocol Securised) type, thus enabling content providers, after identification, to access the statistics of access to the contents provided and stored in the memory 105. A content provider can access only the statistics of the contents that he has provided. The server 101 therefore has a table, not shown, to associate each content identifier with a content provider identifier.

In one improvement of this variant, for each recording of the memory 105, and for each type of terminal of the recording, the operator manages one counter per day. This enables the content provider connecting up to the server 101 through the HTTPS protocol to be able to consult detailed statistics of access to his contents.

In another variant of the invention, the access statistics are sent at regular intervals for each recording of the memory 105 for which an address for the sending of statistics has been provided. In this variant, an address, for example an electronic mail address type of address, is provided through a field 123 of the configuration message 108. This address is then recorded in the field 105d of the recording of the memory 105 with which this address is associated.

In the present description, the configuration of the broadcast has been described as being done through a single configuration message. In practice, this configuration can be made through several configuration messages. The field 110 of the configuration message 108 indeed makes it possible to determine which recording of the memory 105 must be updated as a function of the content of the message 108. It is thus possible to add a type of terminal, change an address for sending statistics, change a duration, etc.

1. A method for the broadcasting of multimedia messages to a fleet of terminals wherein:
a server of a telephony operator receives a message of configuration of broadcasting of a multimedia content, the configuration message comprising at least one service identifier field, one identifier field of a type of terminal and, for each type of terminal identified by the configuration message, an associated multimedia message, a multimedia message being compatible with the type of terminal with which it is associated,
the operator's server records the configuration message in a storage memory, the configuration message being then identified in the storage memory by the service identifier, each multimedia message of the configuration message being associated with this service identifier,
the operator's server sends at least one message of notification of reception of a multimedia message to at least one mobile terminal of a subscriber with the telephony operator, the notification message comprising a multimedia message identifier field itself comprising at least one service identifier field whose content is that of the service identifier field of the configuration message, the subscriber being referenced in a subscriber database.

2. A method according to claim 1, wherein:
the operator's server receives a multimedia message retrieval message, the retrieval message comprising a type-of-terminal field and, in a multimedia message identifier field, a service identifier field, and,
the operator's server scans the storage memory to find a configuration message identified by the content of the service identifier field,
the operator's server scans the configuration message found to find a multimedia message identified by content of the type-of-terminal field,
the operator's server sends the multimedia message found in response to the retrieval message.

3. A method according to claim 1, wherein the multimedia message identifier field of the notification message also has a type-of-terminal field, the content of this type-of-terminal field being extracted from the subscriber database.

4. A method according to claim 3, wherein:
the operator's server receives a message for the retrieval of a multimedia message, the multimedia message identifier field of the retrieval message comprising a multimedia message identifier field and a type-of-terminal field,
if there is no identity between the type-of-terminal field of the retrieval message, and the type-of-terminal field of the multimedia message identifier field, then the server of the operator updates the subscriber database to take account of the change in terminal of the subscriber,
the operator's server scans the storage memory to find a configuration message identified by the content of the service identifier field,
the operator's server scans the configuration message found to find a multimedia message identified by content of the type-of-terminal field of the retrieval message,
the operator's server sends the multimedia message found in response to the retrieval message.

5. A method according to claim 2 wherein if, in the configuration message found, there is no multimedia message corresponding to the content of the type-of-terminal field of the retrieval message, then the server sends a default multimedia message.

6. A method according to claim 1, wherein:
the operator's server receives a transfer message comprising a recipient identifier field, and a multimedia message identifier field comprising a service identifier field,
the server sends the terminal identified by the recipient identifier field a notification message comprising, in a multimedia message identifier field, the content of the service identifier field of the transfer message.

7. A method according to claim 1, wherein:
the server's operator computes, for each multimedia message of the configuration message, a digital summary of the message, this summary being recorded in a digital summary field associated with the multimedia message in the storage memory.

8. A method according to claim 7, wherein:
the operator's server receives a transfer message, the transfer message comprising a recipient identifier field, and a multimedia message,
the operator's server computes a digital summary of the multimedia message of the transfer message,
the operator's server makes a search in the storage memory for the multimedia message for which the content of the digital summary field corresponds to the digital summary computed for the multimedia message of the transfer message,
the operator's server sends the terminal, identified by the content of the recipient field of the transfer message, a notification message comprising, in a multimedia message identifier field, a service identifier field whose content is the content of the service identifier field associated with the multimedia message found in the storage memory.

9. A method according to claim 1, wherein the operator's server associates at least one access computer with each service identifier.

10. A method according to claim 1, wherein the configuration message includes an address for the sending of access statistics.
